(19) United States
(12) Patent Application Publication
(10) Pub. No.: US 2007/0050220 A1
(43) Pub. Date: Mar. 1, 2007

(54) Health care provider payment assurance

(76) Inventors: John Matthew Burghardt, Sterling Heights, MI (US); Gerald Joseph Filipek, Clinton Township, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/514,473

(22) Filed: Sep. 1, 2006

Related U.S. Application Data
(60) Provisional application No. 60/713,581, filed on Sep. 1, 2005.

(51) Int. Cl. G06Q 40/00

(52) U.S. Cl. 705/4; 705/35

(57) ABSTRACT

A process for providing payment of a patient's share of health care treatment and products comprises issuing a medical expense credit card to the patient, wherein payments charged are not made until approved by a third party administrator. An audit of charges is performed by a third party administrator and payment is released if the charges and the patient's share are approved by the administrator. Fees can be deducted from the payments when they are made.

### CROSS-REFERENCE TO RELATED APPLICATIONS

This is a continuing non-provisional application of co-pending U.S. provisional Patent Application Ser. No. 60/713,581, entitled Health Care Provider Payment Assurance, filed on Sep. 1, 2005, by John Matthew Burghardt and Gerald Joseph Filipek, the disclosure of which is incorporated herein by reference.

### BACKGROUND OF THE INVENTION

The invention relates to health care provider payment arrangements and more particularly is directed to patient payment to their health care provider.

The present status of health care payment procedures and thus availability of health care have come through a period of time in which health care became widely available and was commonly provided by various employer and government programs.

The end users or the consumers, namely, the patients have generally not had an awareness of or a concern for either judicious application of health care services or their associated costs. Rather, a perceived right to all of the latest medical advances in every instance, no matter whether appropriate and no matter how lavish beyond utility, have become a cultural norm. While the growth of this environment has applied development pressures that stimulate significant advancement in medical diagnostics and treatments, the environment has also resulted in unproductive utilization of medical resources. Coincident to this cultural development of a perceived right to access the latest medical resources at all times has been a growth of medical litigation.

These two powerful factors in the development of the health care market have proceeded substantially unchecked. The most effective check in the development of any market is the conscientious interaction of the market consumer with the market by the judicious application of purchase dollars. The health care market consumer, namely, the patient, has effectively been substantially segregated from the medical care market, however, by a generous availability of third party payment for medical care, namely, insurance that has been provided by employer and by government programs, leaving the patient to merely consume without actually participating in the purchase.

Health care expenses have come to levels where the prior purchasers, namely, employer and government programs, are no longer financially able or willing to bear the full cost of medical care. Thus, there has been a growth of a trend toward increasing patient participation in the cost and the management of health care services. This trend is manifesting with increasing co-pay arrangements, for example. The tradition of the provision of health care without patient purchase participation is deeply rooted, however. Thus, patients are slow to take on their relatively new obligation of participating in paying the costs of health care, which is developing patient payment receivable accounts. Patient payment receivable accounts are not only developing, they are growing and significant numbers of these accounts are becoming bad debts to the health care provider.

As patient accounts payable to the health care providers grow, the accounts become a financial burden upon the provision side of the health care market, especially as the accounts become uncollectible. The health care market adjusts for unpaid receivable accounts with increased overhead that increases health care service fees.

Thus, patient participation in purchasing health care is not having the desired effect of reducing health care costs. Growing patient accounts that are payable to health care providers are offsetting and consuming the opportunity to press health care costs down. One may, then, see that a new approach to health care provider payment arrangements and more particularly to patient payment to their health care provider is needed to lift the financial burden of patient accounts payable to the health care providers. When this financial burden is lifted, then health care costs may reflect the costs of providing health care without including costs of financing health care, and the true cost of health care may more be identified more readily and may also be controlled.

### BRIEF SUMMARY OF THE INVENTION

Accordingly, a health care provider payment assurance process of the invention provides a method of processing and paying a patient's healthcare expenses (including care and medication expenses), whether one or combination of portions are payable by insurance and the patient.

In one aspect of the invention, the patient is provided with a healthcare charge card. The charge card is issued by a lending institution that issues a loan to the patient for payment of the patient's share of at least certain medical bills. The card has the characteristic that designated charges are held in suspense as a credit hold, until the charges are approved by a designated healthcare clearance or auditing agency.

In another aspect of the invention, a patient's bill for medical services and products is provided to the healthcare clearance agency. The bill may be accompanied by an assessment or explanation of benefits (“EOB”) by the patient's provider regarding what portion of charges may be payable by the patient and what portion of charges may be payable by the insurance provider or other designated third party.

Further, the healthcare clearance agency may conduct an audit regarding the accuracy of the charges and charge allocations to any insurance carrier and patient. The credit hold may be released on completion of the audit to the extent charges are approved by the clearance agency. Payments relating to disputed charges may be withheld, and fees or discounts applicable to the transaction may be retained from the payment.

Whereby, healthcare providers may provide healthcare services and products to patients having one or a combination of no insurance, partial insurance, and full insurance and receive prompt payment of the agreed amount of both health care provider and patient portions of a bill. Further, the patient may receive a prompt audit of the patient's liability for charges and an extension of credit and automatic payment of the appropriate portion owed by the patient.

These and other features, objectives, and benefits of the invention will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is a schematic diagram of care and cost tasks of each of a health care provider and an insurance company portion of a health care provider payment assurance process of the invention;

FIG. 2 is a schematic diagram of the tasks of a health care provider payment assurance company portion thereof; and

FIG. 3 is a schematic diagram of the tasks of a participating banking entity thereof.

### DETAILED DESCRIPTION

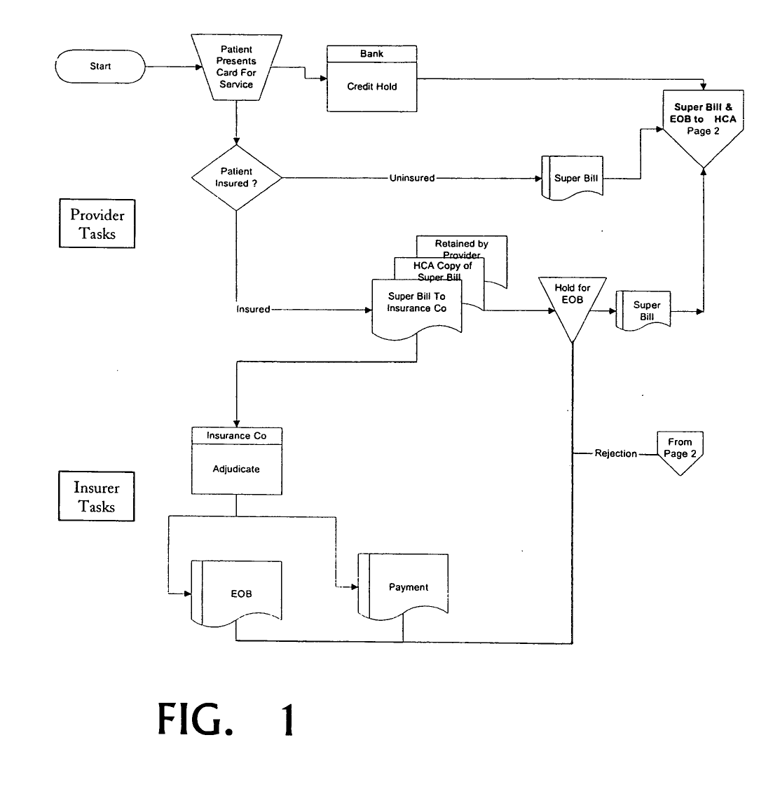

A preferred embodiment of a health care provider payment assurance process according to the invention is schematically shown in the drawing figures and discussed below. One having ordinary skill in the art of health care services payment arrangements will recognize the schematic diagram of FIG. 1 as presenting a general interaction of a health care provider [HCP or Provider] with its patient and with a third party payer [TPP] or insurance company, and as also presenting some elements that are unique to the present invention, including at least interactions of the Provider with a patient's payment bank and with a health care assurance entity [HCA or Auditor] of the invention.

In the normal course of treatment or consultation, a patient will commonly appear for an appointment with the Provider 10 and present current and historical medical condition information as well as payment and insurance information to the Provider. The Provider will determine the insurance status of the patient based upon the insurance information provided and confirmation with the insurance company that is identified by the patient. A statement 102 of the Provider's charges for the appointed consultation or treatment is issued to the insurance company if the patient has insurance to some degree as shown in FIG. 1 at insured path branch 100. The Provider's statement of charges may in the trade be called a ‘Super Bill.’ Alternatively, the statement of charges 204 will be issued to the patient if the patient does not have insurance as indicated at uninsured path 200.

When the Provider's statement 102 is presented to the insurance company, the health care procedures charged are adjudicated 1 10 against a health care contract or insurance policy with the patient. This adjudication is the insurance company's determination of whether the procedures charged are covered under the health care contract and to what extent the insurance company is required to pay for the procedures. The result is a statement of the insurance company's determination in an explanation of benefits [EOB] 112 and payment 114 from the insurance company to the Provider in an amount as determined and stated in the explanation of benefits.

The explanation of benefits and payment are customarily returned to the Provider within about forty-five (45) days from submission of the Super Bill 102 by the Provider. After the Provider receives the explanation of benefits and payment from the insurance company, a revised statement 104 of the Provider's charges that includes the insurance payment and the explanation of benefits is prepared and issued to the patient.

The above customary health care provider payment procedure is modified according to the present invention with inclusion in the billing process of a health care assurance entity [HCA or Auditor] 300 with the patient. The inclusion of the health care assurance entity is not dependant upon the presence of health care insurance. The Auditor 300 may, in a sense, be considered as a liaison between the Provider and the patient, which provides benefits to each of the patient and the Provider. A financial entity that is referred to as Bank 400 for the purposes of this disclosure is also included in the billing and payment process.

The Bank 400 is arranged by the Auditor 300 and contracts with the patient to extend credit to the patient expressly for health care, including payment to the Provider upon authorization from the health care assurance entity 300. The Auditor is named as an authorized entity in the credit contract and may be said to act as an agent of the patient to authorize payment in this arrangement as will be further understood with further disclosure below. This credit contract may specify additional qualifying medical care transactions.

With reference back to the presentation of the patient at the Provider for care 10, the Bank 400 is identified as a participant in the process at the point when the patient presents payment and insurance information to the Provider. An anticipated form of identifying participation of the Bank in the process may include use of a patient identification card that has a dual function as a health care credit card that ties back to the Bank credit agreement with the patient. Further, the Bank may be said to become active in the process at the point when the Provider issues the statement of charges or Super Bill, either 102 or 204, which should coincide closely after the end of the patient's appointment with the Provider. In either case of the patient being insured or being uninsured, an estimated amount of the patient's obligation to pay the Provider is placed as a credit hold on the patient's credit with the Bank 400, and the Auditor 300 is notified of the credit hold. The credit hold will later be released upon a payment authorization order from the health care assurance entity 300 as is discussed further below.

Similar to the Bank 400, the Auditor 300 is also identified as a participant in the process at the point 10 when the patient presents payment and insurance information to the Provider. The Auditor 300 may be said to become active further in the process at the point when the Provider issues the statement of charges or Super Bill, either 104 or 204. The same form of identification that identifies the Bank 400 as a participant in the payment process may further serve a third function of also identifying the Auditor 300. Thus, the Super Bill 104 or 204, depending upon the insurance status of the patient, is issued to the Auditor 300.

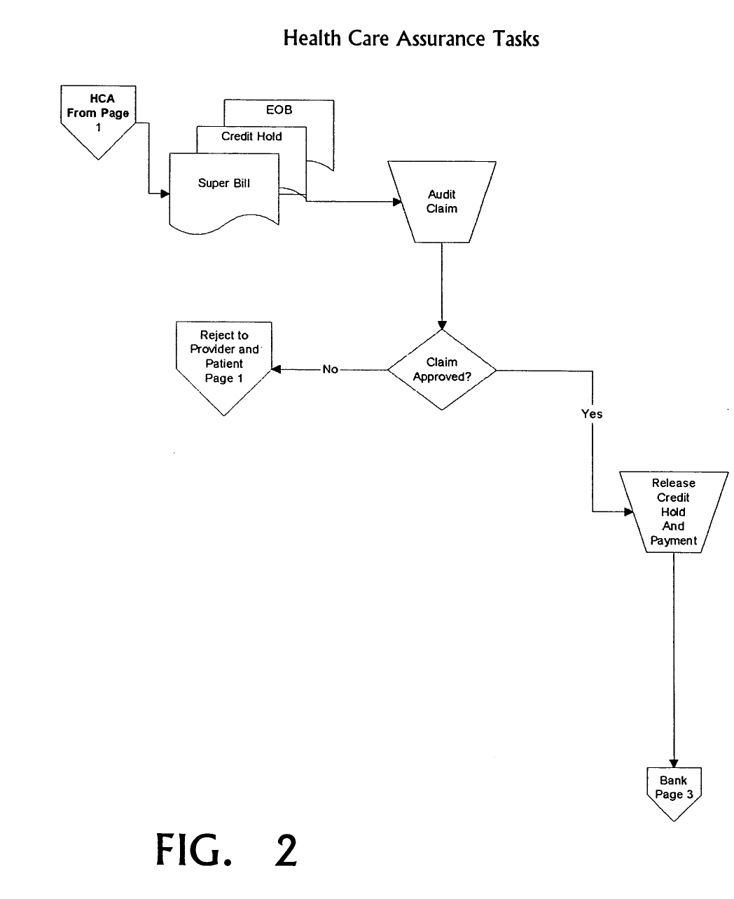

After and preferably upon receipt of each of the credit hold notice and the Super Bill, which includes the statement of the Providers charges and the explanation of benefits, the Auditor 300 proceeds to audit 302 each piece of the billing process information (FIG. 2). Each of the explanation of benefits 112 from the insurer, if the patient is insured, and the statement of charges 104 or 204 from the Provider are audited for accuracy, including internal consistency, and against established protocol profiles, including known treatment paths and best practices, for irregularities. The audit may also consider whether the amount of the credit hold is appropriate.

If the claim is not approved because the Auditor 300 finds an irregularity in the audit, then an audit report rejection is forwarded to the Provider and to the Patient. An irregularity by the Provider may then be addressed by the Provider and a restatement of charges issued to the Auditor 300. Alternatively, an irregularity by the insurance company may then be pursued by the patient and a restatement of the explanation of benefits may be issued to the Auditor. Whether a statement of charges from the Provider or an explanation of benefits from the insurance company is reissued, the claim is re-audited.

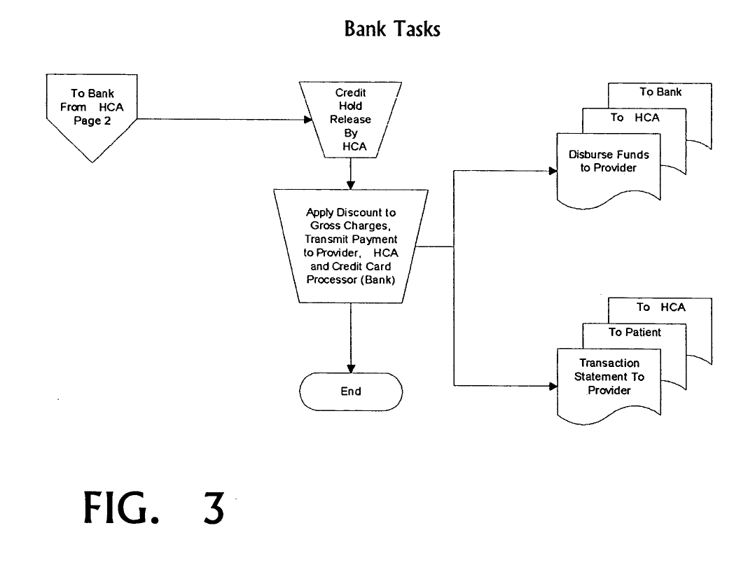

Upon approval of the claim, the Auditor 300 issues a pay order to the Bank 400 at step 304 of the diagramed process (FIGS. 2 and 3). The credit hold is released, and the actual amount payable by the patient is applied to the patient's credit line. An explanation of the audit results and a receipt for the credit card transaction are sent to each of the patient and the Provider. The disbursement of the charged funds is made to the Provider and in part to the Auditor.

An enticement to a Provider to join in a health care provider payment assurance process of the invention is to increase patient payment collections and to reduce business operations costs that are associated with collections. While the insurance company portion of a provider's compensation is generally established and paid in an about forty-five day payment cycle, the payment cycle of the patient portion generally begins at about the forty-five day insurance payment and may extend indefinitely from there under prior Provider compensation procedures. The patient payment may ultimately become an uncollectible account.

The health care provider payment assurance process of the invention significantly reduces the business risk that is inherently associated with collection of receivable accounts generally and in patient receivable accounts in particular. In one advantage, receivable accounts aging is reduced by payment within days of the insurance company forty-five day payment cycle. In another advantage to the Provider, payment is assured by a previously established line of credit that is held for payment to the Provider. These and other advantages may result in the Provider realizing an about 4.4% (percent) increase in cash flow and may accelerate collections over twenty times for accounts that are subject to a health care assurance audit of the invention. Further, such accounts will not become bad debts to the Provider. Overhead of the Provider business operation is reduced with participation in a health care provider payment assurance process of the invention because of a reduced collection burden and also because of shifting or out-sourcing of some tasks to the Auditor 300.

Thus, a portion of the savings realized by implementation of the invention may be allocated to compensation of the Auditor's services. Further, the provider may reduce his schedule of charges according to the cost savings realized.

An enticement to a patient to join in a health care provider payment assurance process of the invention, whether the patient has health insurance coverage or not, is a provision of an assurance through the Auditor's audit that established protocol profiles, including known treatment paths and best practices, are adhered to and documented and that they are properly charged. This added peace of mind because of the auditor is not charged to the patient. Rather, the auditor's fee may be charged as a percentage of any cost savings realized by the patient as a result of the audit. For example, if an audit saves a patient $100, the auditor may charge a fee of 20% of the savings, or $20. This fee would be charged to the patient on his medical credit card and would partially offset the $100 savings.

Referring again to the step 304 of the process, the credit hold is released and the actual amount payable by the patient is paid to the service provider by the bank, upon approval of the claim by the Auditor 300 and its issue of a pay order to the Bank 400. The actual amount paid by the bank may be discounted by an amount agreed to by the Provider as a fee for the guaranteed payment. Assuming a fee of 7.5%, the fee may be divided between the Auditor and the bank to cover the cost of the audit as well as the bank charges. Whether a fee is charged and the amount of the fee depend on the financial arrangements among the participants. In any case, it is contemplated that the process can be implemented without charge to the patient, except for interest payable on the credit extended, even including compensation of the Auditor.

Thus, the schematic diagram portion shown in FIG. 3 includes the credit hold release 304, the application to the patient's credit line of the amount payable by the patient 402, the disbursement of funds 404, and reporting of transactions 406. More specifically, the discounted disbursement to the Provider and the allocation of compensations to each of the Auditor and the Bank is applied to the credit line 402, with actual transfer or disbursement of finds 404. Recordation of the transactions may be by either electronic confirmation or tangible documentation, each of which is known.

The present invention applies to any type of medical expense (including drugs, devices, or supplies, as well as medical care) where at least a portion of the expense is payable by the patient. In a transaction involving the purchase of drugs or medical supplies, the patient share (co-pay or uninsured payment) can be purchased with the medical credit card and provided to the Auditor for audit and payment authorization.

The process provides prompt payment to the Provider at substantially less cost than the administration and collection of individual accounts, while giving patients the comfort of an audit and assurance that bills will be paid. The audit service desirably is performed with the assistance of a computer program that compares actual charges with other criteria necessary to determine the appropriateness of specific charges.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, are used in the detailed description of the invention and in the claims only to convey relative positioning of various elements of the claimed invention.

What is claimed is:

1. A process for processing and paying a patient's healthcare expenses having one or a combination of portions payable by insurance and the patient comprising:
providing the patient with a healthcare charge card whereby a lending institution loans money to the patient for payment of at least certain medical bills, the card having the characteristic that designated charges are held in suspense until the charges are approved by a designated healthcare clearance agency;
providing a patient's bill for medical services and products to the healthcare clearance agency, the bill containing any assessment by the healthcare provider of the portion of charges payable by the patient and the portion of charges payable by any designated insurance provider;
conducting an audit by the healthcare clearance agency as to the accuracy of the charges and charge allocations to any insurance carrier and patient;
providing a release of the credit hold to the credit provider to the extent of approved charges, withholding payment of disputed charges and retaining from the payment any fees or discounts applicable to the transaction, whereby healthcare providers can provide healthcare services and products to patients having one or a combination of no insurance, partial insurance, and full insurance and receive prompt payment of the agreed amount of both the health care provider and the patient portions of the bill, while the patient receives a prompt audit of the patient's liability for charges and an extension of credit to pay the appropriate portion owed by the patient.

2. A process according to claim 1 wherein the credit approval, payment, and audit are performed electronically by computer, wherein the computer that approves of a payment has access to electronic data representative of the elements in the healthcare provider's bill, the insurance company's contract with the patient, including liability limits and co-pay provisions, and other data necessary for a payment decision, the use of such electronic equipment making it possible to render an audit and make payment almost instantaneously.

3. In a health care payment plan in which a patient has a patient account that is dedicated to health care service payment and that is identified to the patient and in which a third party may pay a predetermined health care service, the improvement of a health care provider payment assurance method comprising the steps of:
providing a provisional debt on the patient account upon the incurrence of a health care charge by a health care provider;
providing a comparison of the health care charge against predetermined health care charge criteria and creating a comparison report that identifies an audited health care charge;
applying a predetermined adjustment to the audited health care charge and identifying a resulting payment amount that is payable to the health care provider;
releasing the provisional debt and applying the audited health care charge to the patient account;
providing payment of the resulting payment amount to the health care provider;
providing the comparison report to at least one of the health care provider and the patient; and
providing a processing unit that is adapted to facilitate the steps of the health care assurance method.

4. The method of claim 3 wherein the step of providing a comparison of the health care charge against predetermined health care charge criteria and creating a comparison report that identifies an audited health care charge is a health care services audit that is conducted according to a preselected audit criteria and wherein the method further includes a step of allocating at least a portion of a difference between the audited health care charge and the resulting payment to the health care provider to the procedure of the audit.

5. The method of claim 4 further including the step of providing a processing unit that is adapted to provide the health care services audit, and wherein the health care services audit is performed by the processing unit.

6. A process for paying for the patient's share of expenses for medical treatment and medical products comprising:
issuing to the patient a medical expense credit card from a financial institution for payment of the patient's share, a characteristic of the credit card being that expenses that are charged with the card are not paid until the expenses are approved by a third party administrator;
providing an audit of the patient's bill by a third party administrator in order to confirm the appropriateness of the charges to the patient; and
providing a payment release to the financial institution upon approval of the amount payable on behalf of the patient.
